(19) United States
(12) Patent Application Publication
(10) Pub. No.: US 2020/0359617 A1
(43) Pub. Date: Nov. 19, 2020

(54) Trash Receptacle Protection Apparatus

(71) Applicant: Gary Milan Savara, Sudbury (CA)

(72) Inventor: Gary Milan Savara, Sudbury (CA)

(21) Appl. No.: 16/814,745

(22) Filed: Mar. 10, 2020

Related U.S. Application Data
(60) Provisional application No. 62/848,778, filed on May 16, 2019.

(51) Int. Cl. A01M 29/24; B65F 1/14

(52) U.S. Cl. CPC A01M 29/24; B65F 2210/156; B65F 2210/139; B65F 1/14

(57) ABSTRACT

A trash receptacle protection apparatus that is configured to be releasably secured to a trash receptacle so as to inhibit animals from entering the interior volume thereof. The trash receptacle protection apparatus includes a body wherein the body is ring shaped and manufactured from an elastic material. The body further includes a plurality of conductors wherein the conductors are distributed in between the lower edge and upper edge. Voids are present in between the plurality of conductors and the conductors are manufactured from a stainless steel wire. The conductors are formed in a z-pattern so as to accommodate the expansion of the body during securing to trash receptacles of larger sizes. The body of the present invention further includes a plurality of warning indicia and further includes a warning light.

### PRIORITY UNDER 35 U.S.C. Section 119(e) & 37 C.F.R. Section 1.78

This nonprovisional application claims priority based upon the following prior United States Provisional Patent Application entitled: Trash Receptacle Protection Apparatus, application Ser. No. 62/848,778 filed May 16, 2019, in the name of Gary Milan Savara, which is hereby incorporated by reference for all purposes.

### FIELD OF THE INVENTION

The present invention relates generally to refuse receptacles, more specifically but not by way of limitation, an apparatus configured to be releasably secured to a trash can wherein the apparatus provides an electronic barrier operable to discourage animals from entering and/or accessing the interior volume of the trash can.

### BACKGROUND

As is known in the art, in certain areas both rural and urban both domestic and wild animals will attempt to access trash cans. Once the trash is disposed within the interior volume of the trash can the trash attracts various animals such as but not limited to racoons and dogs. Depending upon where an individual lives other animals such as but not limited to bears can further be an issue. It is desirable that a homeowner inhibit the access of animals to the trash disposed within an interior volume of the trash can. Conventionally, this objective is accomplished through mechanical devices such as but not limited to locks or lid structures wherein the mechanical devices inhibit access to the interior volume through restricted movement or access to the trash can lid. While these can be somewhat effective, many types of animals are still able to bypass and access the interior volume of the trash can leading to an undesirable spread of trash for the homeowner.

Another technique for attempting to inhibit access to the interior volume of the trash can is to store the trash can inside. While this obviously inhibits access by unwanted animals, the drawback to such a resolution is that the interior of the area where the trash can is kept is compromised from a sanitary and olfactory perspective. Commonly, a homeowner will attempt to keep their trash can within a garage or similar structure of the house and the resulting negative impacts are undesirable.

It is intended within the scope of the present invention to provide trash receptacle protection apparatus that is operable to inhibit access to the interior volume of the trash receptacle through utilization of electricity so as to provide an ability for a homeowner the ability to store the trash can and contents thereof outside.

### SUMMARY OF THE INVENTION

It is the object of the present invention to provide a trash can receptacle barrier that is configured to inhibit access to the interior volume of the trash can receptacle wherein the present invention includes a body that is formable in shape.

Another object of the present invention is to provide a trash can access barrier that is configured to provide an electrical shock to animals attempting to access the interior volume of the trash can wherein the body is manufactured from an elastic material so as to facilitate releasable securing to various shapes of trash cans.

A further object of the present invention is to provide a trash can receptacle barrier that is configured to inhibit access to the interior volume of the trash can receptacle wherein the body in a preferred embodiment is a circular band approximately three inches in width.

Still another object of the present invention is to provide a trash can access barrier that is configured to provide an electrical shock to animals attempting to access the interior volume of the trash can that further includes conductors disposed on the body of the present invention.

An additional object of the present invention is to provide a trash can receptacle barrier that is configured to inhibit access to the interior volume of the trash can receptacle wherein the conductors are arranged in a parallel configuration on the body of the present invention.

Yet a further object of the present invention is to provide a trash can access barrier that is configured to provide an electrical shock to animals attempting to access the interior volume of the trash can wherein the conductors are manufactured from a stainless steel wire in a preferred embodiment of the present invention.

Another object of the present invention is to a provide a trash can receptacle barrier that is configured to inhibit access to the interior volume of the trash can receptacle wherein the conductors are sewn in a zig-zag pattern so as to allow stretching thereof during expansion of the body during securing to a trash can.

An alternate object of the present invention is to provide a trash can access barrier that is configured to provide an electrical shock to animals attempting to access the interior volume of the trash can wherein the body is electrically coupled to a voltage generator.

Still a further object of the present invention is to provide a trash can receptacle barrier that is configured to inhibit access to the interior volume of the trash can receptacle wherein the present invention utilizes a high voltage across the body thereof such as but not limited fifteen hundred volts.

An additional object of the present invention is to provide a trash can access barrier that is configured to provide an electrical shock to animals attempting to access the interior volume of the trash can wherein the present invention further includes a visual indicator to provide notification of an electrical charge present on the body.

A further object of the present invention is to provide a trash can receptacle barrier that is configured to inhibit access to the interior volume of the trash can receptacle wherein the present invention utilizes a LED light as a visual indicator.

An alternative objective of the present invention is to provide a trash can access barrier that is configured to provide an electrical shock to animals attempting to access the interior volume of the trash can wherein the conductors are presented with sufficient voltage so as to transmit across the entire body of the present invention.

Yet a further object of the present invention is to provide a trash can receptacle barrier that is configured to inhibit access to the interior volume of the trash can receptacle wherein the body further has disposed thereon indicia providing warning to individuals of the electrical charge thereon.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention operably coupled to a trash receptacle.

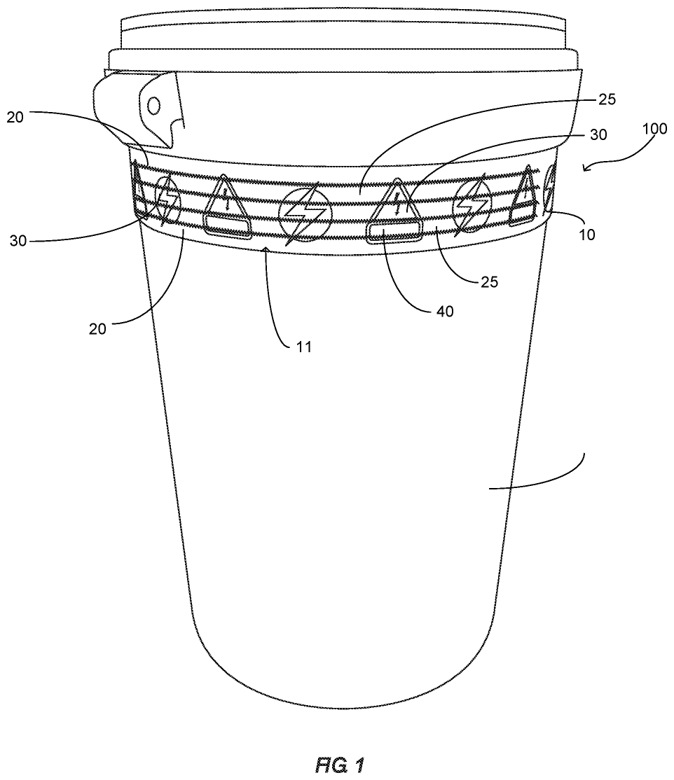

### DETAILED DESCRIPTION

Referring now to the drawings submitted herewith, wherein various elements depicted therein are not necessarily drawn to scale and wherein through the views and figures like elements are referenced with identical reference numerals, there is illustrated a trash receptacle protection apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the drawing submitted herewith, the trash receptacle protection apparatus 100 further includes a body 10. The body 10 is designed to be circumferentially mounted to a conventional trash receptacle 99. The body 10 is formable in shape and is manufactured from an elastic and non-conductive material. It is contemplated within the scope of the present invention that the body 10 could be releasably secured to various alternate sizes and shapes of trash receptacles 99. In order to facilitate the ability to perform the aforementioned, the body 10 is manufactured from an elastic material wherein during securing of the body 10, the body 10 is expanded and applies an inward force to the trash receptacle 99 once secured thereto in order to facilitate the maintenance of the position thereof. While illustrated herein as being proximate the top of the trash receptacle 99, it should be understood within the scope of the present invention that the body 10 could be placed in various positions thereon. In a preferred embodiment the body 10 is approximately three inches in width. While the trash receptacle protection apparatus 100 has a preferred body 10 width of three inches, it is contemplated within the scope of the present invention that the body 10 could be manufactured in alternate widths. It is intended to manufacture the body 10 of a sufficient width so as to engage a paw or portion of an animal ensuring sufficient contact therewith in order to apply a voltage for deterring further engagement with the trash receptacle 99.

Disposed on the body 10 are a plurality of conductors 20. The conductors 20 are secured onto the surface 11 of the body 10 utilizing suitable techniques and are present completely therearound. The conductors 20 are manufactured from a conductive material such as but not limited to stainless steel wire. While stainless steel wire is a preferred embodiment, it is contemplated within the scope of the present invention that the conductors 20 could be manufactured from various alternate conductive metals.

The conductors 20 are arranged in a parallel pattern on the surface 11 of the body 10. While no particular spacing in between the parallel rows of conductors 20 are required, good results have been achieved utilizing a spacing of one quarter inch between each row of conductors. The aforementioned spacing ensures the ability to transfer a voltage to a smaller animal as well as a larger animal. The parallel pattern of the conductors 20 extends intermediate the lower edge 8 and upper edge 9 of the body 10. The conductors 20 are structured with a void 25 therebetween. The structuring of the conductors 25 with a void 25 therebetween provides the ability to ensure coverage of the surface 11 of the body 10 while utilizing a reduced amount of material. The conductor 20 arrangement with the voids 25 between each adjacent conductor 20 is arranged to ensure a voltage transfer to an animal that has engaged with the receptacle 99. While four conductors 20 are illustrated on the embodiment of the trash receptacle protection apparatus 100 herein, it should be understood within the scope of the present invention that the body 10 could be configured with less or more than four conductors 20. The conductors 20 are secured to the surface 11 so as to provide the ability to secure the body 10 to a metal receptacle.

The conductors 20 are secured in a z-pattern as is illustrated herein. The z-pattern of the conductors 20 facilitates the ability for the metal thread thereof to accommodate any expansion of the body 10 during placement on a trash receptacle 99 of various sizes. This z-pattern ensures avoidance of damage to the conductors 20 during placement of the body 10 on larger diameter trash receptacles 99. Inhibiting damage to the conductors 20 ensures the ability to apply a consistent voltage across the upper surface 11. While no particular voltage is required, it is contemplated within the scope of the present invention that the trash receptacle protection apparatus 100 utilizes a voltage of approximately fifteen hundred volts. While not particularly illustrated herein, the trash receptacle protection apparatus 100 is electrically coupled to a conventional power source such as but not limited to a one hundred and twenty volt power outlet or a battery power source.

The body 10 has disposed on the upper surface 11 thereof warning indicia 30. The warning indicia is either sewn or imprinted on the upper surface 11 of the body 10. The warning indicia is embodied in various forms as is illustrated herein and is operable to provide a visual indicator to individuals that a presence of a high voltage exists. It is contemplated within the scope of the present invention that various amounts of warning indicia 30 could be present wherein as few as one or a plurality could be utilized.

The body 10 further employs the utilization of a warning light 40. The warning light 40 is a conventional led light that is operable to provide a second visual indication to an individual that a presence of high voltage exists. It should be understood within the scope of the present invention that the body 10 could have more than one warning light 40. Furthermore, it is contemplated within the scope of the present invention that the trash receptacle protection apparatus 100 could have a warning light 40 of various alternate colors.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A trash receptacle protection apparatus comprising:
a body, said body being configured to circumferentially surround a trash receptacle, said body having an upper edge and a lower edge, said body having an outer surface, said body being configured to be expandable and formable to the trash receptacle;
at least one conductor, said at least one conductor being integrally formed into the outer surface of said body, said at least one conductor being disposed substantially around said body, said at least one conductor being manufactured from a electrically conductive metal, said at least one conductor being constructed so as to accommodate expansion of said body; and
wherein the at least one conductor is operably coupled to a power source and is configured to have a voltage transmitting therethrough.

2. The trash receptacle as recited in claim 1, wherein the at least one conductor is arranged in a z-pattern around the outer surface of said body.

3. The trash receptacle as recited in claim 2, wherein the at least one conductor is a stainless steel wire.

4. The trash receptacle as recited in claim 3, wherein said body further includes at least one warning indicia on the outer surface thereof.

5. The trash receptacle as recited in claim 4, and further including a light, said light being disposed on the outer surface of said body, said light operable to illuminate so as to indicate a presence of a voltage.

6. The trash receptacle as recited in claim 5, wherein the at least one conductor transmits approximately fifteen hundred volts therethrough.

7. A trash receptacle protection apparatus configured to deter access of the interior volume of the trash can by an animal comprising:
a body, said body being formable in shape, said body being configured to circumferentially surround trash receptacles of alternate sizes and shapes, said body having an upper edge and a lower edge, said body having an outer surface, said body being manufactured from an elastic and nonconductive material;
a plurality of conductors, said plurality of conductors being integrally formed into the outer surface of said body, said plurality of conductors being disposed substantially around said body, said plurality of conductors being manufactured from stainless steel wire, said plurality of conductors being constructed so as to accommodate expansion of said body, said plurality of conductors having voids therebetween; and
wherein the plurality of conductors are operably coupled to a power source and is configured to have a voltage transmitting therethrough.

8. The trash receptacle protection apparatus as recited in claim 7, wherein said plurality of conductors are z-shaped.

9. The trash receptacle protection apparatus as recited in claim 8, wherein said voids intermediate said plurality of conductors are approximately one quarter inch.

10. The trash receptacle protection apparatus as recited in claim 9, and further including a light, said light being disposed on the outer surface of said body, said light operable to illuminate so as to indicate a presence of a voltage.

11. The trash receptacle protection apparatus as recited in claim wherein said body further includes a plurality of warning indicia on the outer surface thereof.
